(19) United States
(12) Patent Application Publication
(10) Pub. No.: US 2007/0116117 A1
(43) Pub. Date: May 24, 2007

(54) Controlling buffer states in video compression coding to enable editing and distributed encoding

(75) Inventors: Xin Tong, Mountain View, CA (US); Hsi-Jung Wu, San Jose, CA (US); Barin Geoffry Haskell, Mountain View, CA (US)

Correspondence Address: KENYON & KENYON LLP, 1500 K STREET NW, SUITE 700, WASHINGTON, DC, 20005-1257, US

(73) Assignee: Apple Computer, Inc.

(21) Appl. No.: 11/453,143

(22) Filed: Jun. 15, 2006

Related U.S. Application Data
(60) Provisional application No. 60/737,804, filed on Nov. 18, 2005.

(51) Int. Cl. H04N 7/12

(52) U.S. Cl. 375/240.08; 375/240.26

(57) ABSTRACT

An encoder includes a parser, a plurality of encoder engines and an assembler. The parser divides a portion of a received digital data stream into a plurality of segments having a begin boundary and an end boundary. The plurality of encoder engines independently encode the plurality of segments to accommodate a begin buffer status condition corresponding to each begin boundary and an end buffer status condition corresponding to each end boundary, thereby producing a plurality of corresponding encoded segments. The assembler combines the plurality of encoded segments to form a portion of an encoded digital data stream. The encoder engines verify the begin and the end buffer status conditions are satisfied for each encoded segment and also verify each encoded segment prevents an overflow and an underflow of a modeled decoder buffer. Any violating segment is re-encoded and re-verified prior to assembly.

### CROSS REFERENCE TO RELATED APPLICATIONS

This application claims priority to U.S. Provisional Patent Application No. 60/737,804, filed Nov. 18, 2005, herein incorporated by reference in its entirety.

### BACKGROUND OF THE INVENTION

1. Field of the Invention

The present invention generally relates to video encoders. More specifically, the present invention provides the independent encoding of multiple segments of a digital data stream to produce an encoded digital data stream.

2. Background Art

Encoder-decoder systems are used to efficiently transfer digital information. Many encoders model the performance of an associated decoder, in particular the buffer states therein, to confirm the associated decoder will operate properly. In many instances, a single encoder engine is used to encode an entire digital data stream. For long sequences of digital data, the performance of a single encoder engine can be inadequate and inefficient. Accordingly, multiple independent encoder engines could be used to encode separate segments of a large digital data stream to reduce processing time. These multiple encoder engine systems, however, could not account for the state of a remote decoder buffer because such states would depend in part upon coding decisions by each encoder (to which the other encoders do not have access). Consequently, the assembled encoded segments can cause the remote decoder buffer to enter an underflow or overflow condition. In turn, the decoding process used to recover the original digital data is impaired. Specifically, the decoding and/or associated rendering process can be stalled or distorted.

FIG. 1 illustrates a conventional encoder-decoder system 100. The conventional encoder-decoder system 100 includes a conventional encoder 102 and a decoder 104. The conventional encoder 102 receives source data 106 from a data source 108. The data source 108 can be a hardware device or a software process generating the source data 106. Alternatively, the data source 108 can be a memory device providing the source data 106. The source data 106 is typically a digital data stream comprising data, voice, audio, video and/or multimedia information.

The conventional encoder 102 includes an encoder engine 110 and a transmitter (TX) unit 112. The encoder engine 110 encodes the source data 106 to produce an encoded data stream 114. The encoder engine 110 can be, for example, an encryption engine or a compression engine. Accordingly, the encoded data stream 114 can be an encrypted data stream or a compressed data stream, respectively. As shown in FIG. 1, the transmitter unit 112 directly transmits the encoded data stream 114 to the decoder 104 over a network 116. Alternatively, the conventional encoder 102 can store the encoded data stream 114 in a memory device for store-and-forward delivery to the decoder 104.

The decoder 104 includes a receiver (RX) buffer 118, a decoder engine 120 and a post-processing buffer 122. The decoder 104 receives and temporarily stores the encoded data stream 114 in the receiver buffer 118. The receiver buffer 118 has a specified size or volume. The encoded data stream 114 is loaded into to the receiver buffer 118 at a channel rate. The channel rate is variable and is determined by various factors such as, for example, the transmission rate of the transmission unit 112 and the latency or delay of the network 116. The encoded data stream 114 is removed from the receiver buffer 118 at a frame rate. The frame rate is generally a constant rate (e.g., 30 frames/sec). However, the amount of data contained in each frame can vary substantially. As a result, the rate at which data is drained from the receiver buffer 118 is also variable. Consequently, the receiver buffer 118 can be filled and drained at substantially different rates.

The decoder engine 120 complements the encoder 110. Accordingly, the decoder engine 120 decodes the encoded data stream 114 to produce a decoded data stream 124. The decoded data stream is a replica of the original source data 106. Once recovered, the decoded data stream 124 can be provided to the post-processing buffer 122. The post-processing buffer 122 can provide the decoded data stream 124 to an associated device for further manipulation such as, for example, further processing, display or playback. Alternatively, the post-processing buffer 122 can provide the decoded data stream 124 to a memory device for storage.

FIG. 2 illustrates a graph of instantaneous capacity of the receiver buffer 118 over time. A curve 202 represents the amount of data contained in the receiver buffer 118. As previously mentioned, the receiver buffer 118 can be filled and drained at different rates. Accordingly, the curve 202 can fluctuate considerably during operation of the decoder 104.

A first threshold 204 indicates a maximum capacity of the receiver buffer 118. When the curve 202 exceeds the maximum threshold 206, an overflow of the receiver buffer 118 occurs. Specifically, the receiver buffer 118 is filled to capacity and is unable to accept additional data from the network 116 without destroying currently stored data. During an overflow, portions of the encoded data stream 114 can be lost, thereby hampering or degrading the quality of the decoding process. An overflow condition experienced during video decoding, for example, can cause observable discontinuities in a rendered display of the decoded data. A time segment 206 indicates an overflow condition of the receiver buffer 118.

A second threshold 208 indicates a minimum capacity of the receiver buffer 118. When the curve 202 reaches the minimum threshold 208, an underflow of the receiver buffer 118 occurs. Specifically, the receiver buffer 118 is emptied and remains empty until additional data from the network 116 is received. During an underflow, the receiver buffer 118 is unable to supply the decoder engine 120 with data. An underflow condition experienced during video decoding, for example, can cause the decoding process to be disrupted or stalled. A time segment 210 indicates an overflow condition of the receiver buffer 118.

Underflow and overflow conditions typically violate administrative requirements of an encoding-decoding standard or protocol governing operation of the encoder-decoder system 100. Further, the conventional encoder-decoder system 100 does not provide feedback between the conventional encoder 102 and the decoder 104. That is, the conventional encoder-decoder system 100 does not provide a “backchannel” for the decoder 104 to indicate the status of the receiver buffer 118 to the conventional encoder 102. Therefore, the conventional encoder 102 is unable to use information from the decoder 104 to correct or prevent a buffer overflow or underflow condition by adjusting the encoding of the source data 106.

To prevent overflow and underflow of the receiver buffer 118, the conventional encoder 102 includes functionality to model the status of the receiver buffer 118 at the decoder 104. Specifically, the conventional encoder 102 models the variable amount of data stored in the receiver buffer 118 using factors such as, for example, a bit rate of the encoded data stream 114, an expected channel transmission rate (i.e., a buffer input rate) and a frame rate (i.e., a buffer output rate). Armed with the model of the status of the receiver buffer 118, the conventional encoder 102 can adjust encoding parameters of the encoder engine 110 to ensure the fullness of the receiver buffer 118 is maintained within a desired operating range.

The encoding parameters used by the encoder engine 110 are typically adjusted through an iterative encoding process. That is, the conventional encoder 102 encodes the source data 106 over multiple passes. On a first pass, default encoding parameters are used to encode the source data 106. The resulting encoded data stream 114 is then analyzed to determine if limitations of the receiver buffer 118 will be violated. If a violation is expected or likely, then one or more subsequent passes are implemented. Statistical information gathered during each pass is used to adjust the encoding parameters to re-encode the source data 106 on a subsequent pass. Only when buffer requirements are expected to be satisfied is a final version of the encoded data stream 114 provided to the transmitter unit 112.

The iterative encoding process may allow multiple violations detected in the encoded data stream 114 to be corrected in a subsequent pass. That is, re-encoding the source data 106 to correct a first detected violation can correct later violations within the encoded data stream 114. In this way, the number of passes need to produce an encoded data stream 114 free of violations is not necessarily determined by the number of violations present in the first generated encoded data stream 114.

The “trial-and-error” encoding process implemented by the conventional encoder 102 reduces the likelihood that the receiver buffer 118 will enter an overflow or underflow condition. However, because only a single encoder engine 110 is used to encode the source data 106, the multiple pass encoding process implemented by the conventional encoder 102 is slow and inefficient. Therefore, what is needed is an encoder capable of encoding multiple portions of a data stream separately (e.g., independently or in parallel) such that an entire data stream can be more quickly and efficiently encoded. Further, the encoder should encode the individual segments such that buffer requirements of a corresponding decoder buffer will not be violated for each encoded segment or for a combined or reassembled encoded data stream transmitted by the encoder.

### BRIEF DESCRIPTION OF THE DRAWINGS

The accompanying drawings illustrate the present invention and, together with the description, further serve to explain the principles of the invention and to enable one skilled in the pertinent art to make and use the invention.

FIG. 1 illustrates a conventional encoder-decoder system.

FIG. 2 illustrates a graph of instantaneous capacity of a receiver buffer depicted in FIG. 1 over time.

FIG. 3 illustrates an encoder capable of separately encoding multiple segments of an input data stream according to an aspect of the present invention.

FIG. 4 provides a flowchart of an encoder engine control process for encoding a segment of a data stream to accommodate a set capacity value of an associated remote decoder buffer at the begin and end boundaries of the segment in accordance with an aspect of the present invention.

FIG. 5 provides a flowchart of an encoder engine control process for encoding a segment of a data stream to accommodate a required capacity range of an associated remote decoder at the begin and end boundaries of the segment in accordance with an aspect of the present invention.

FIG. 6 provides a flowchart illustrating operational steps for encoding a portion of a digital data stream using an encoder of the present invention.

FIG. 7A illustrates a first graph of decoder buffer volume that might occur in a hypothetical encoding scenario.

FIG. 7B illustrates the graph of FIG. 7A in which an aspect of the present invention has been applied.

FIG. 8A illustrates a second graph of decoder buffer volume that might occur in a hypothetical encoding scenario.

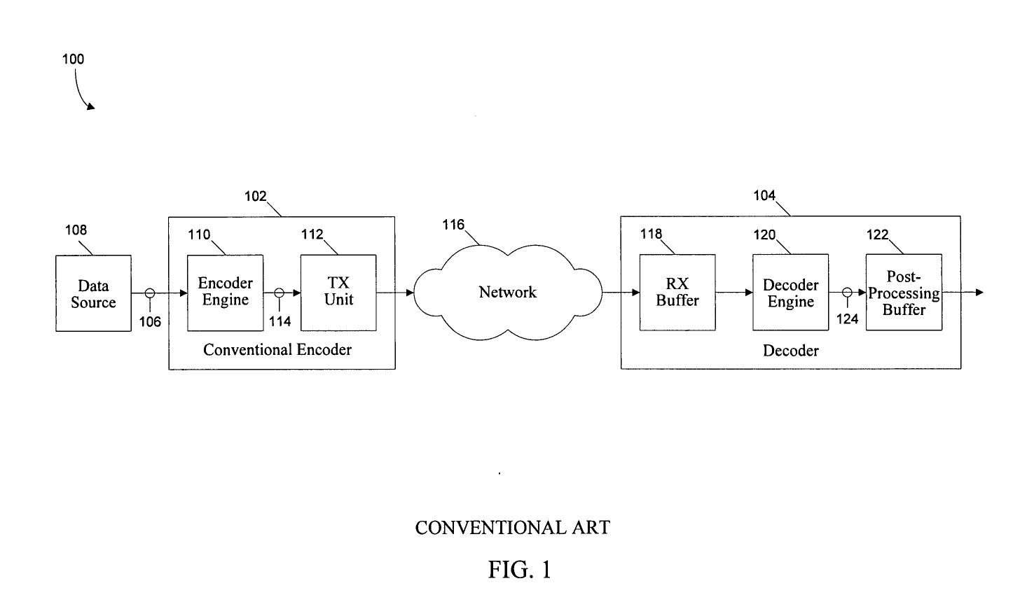

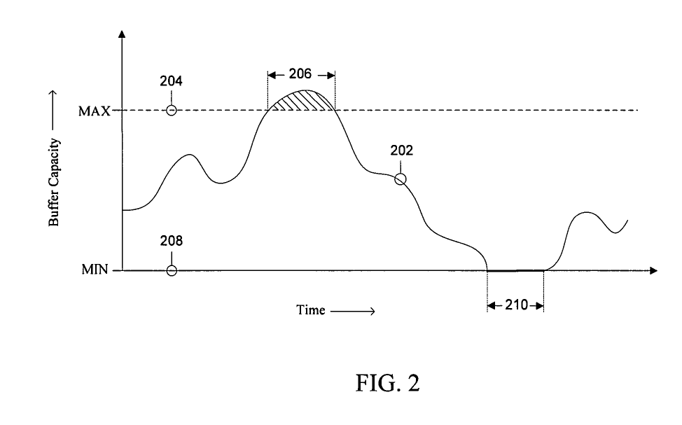

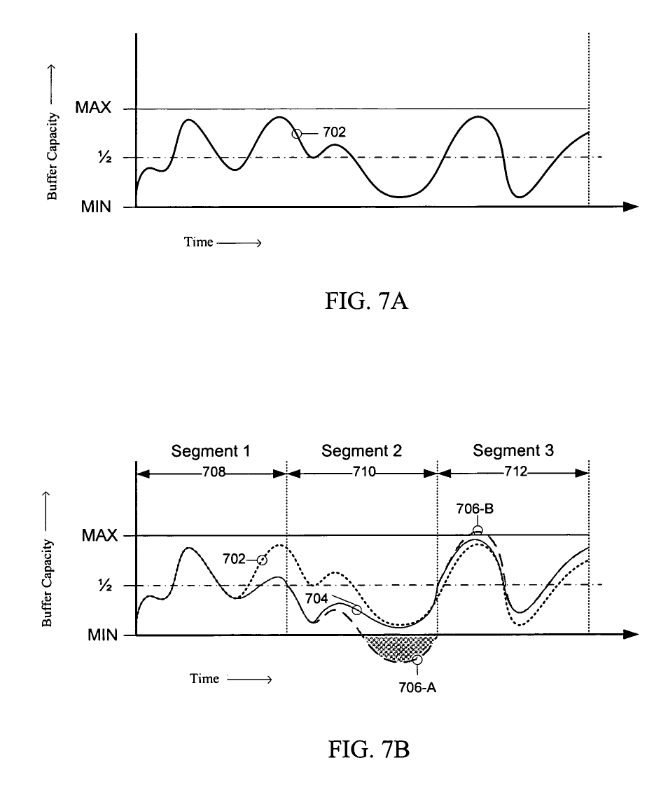

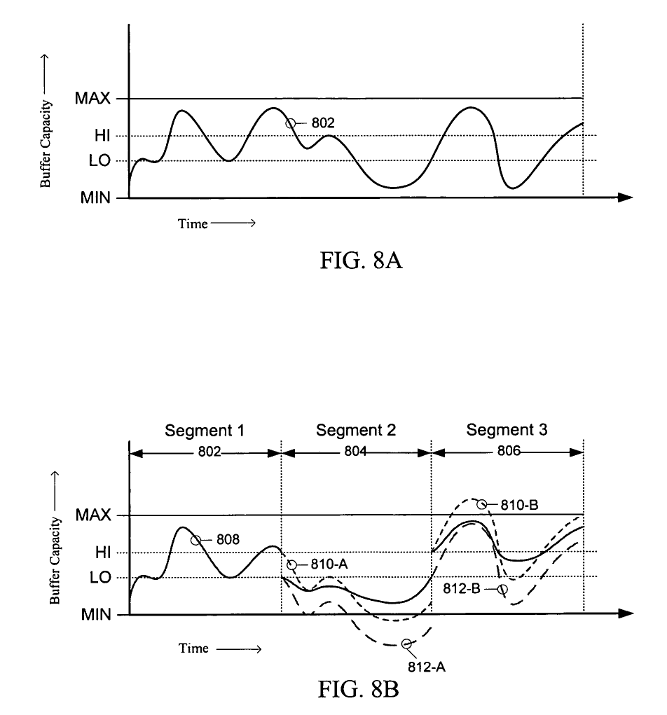

FIG. 7B illustrates the graph of FIG. 8A in which an aspect of the present invention has been applied.

### DETAILED DESCRIPTION OF THE INVENTION

Embodiments of the present invention provide apparatuses and methods whereby independent encoder engines are compelled to code their respective parsed segments so that, at segment boundaries, the buffer status of an associated decoder is forced to some predetermined value (such as a half full state). Embodiments of the present invention provide apparatuses and methods whereby independent encoder engines are compelled to code their respective parsed segments so that, at segment boundaries, the buffer status of an associated decoder is forced to be within some predetermined range of values (such as a MIN and MAX range centered about a half full state). In this regard, the present invention enables independent encoders to encode separate segments of a large digital data stream to reduce processing time while ensuring a remote decoder buffer avoids underflow and overflow conditions.

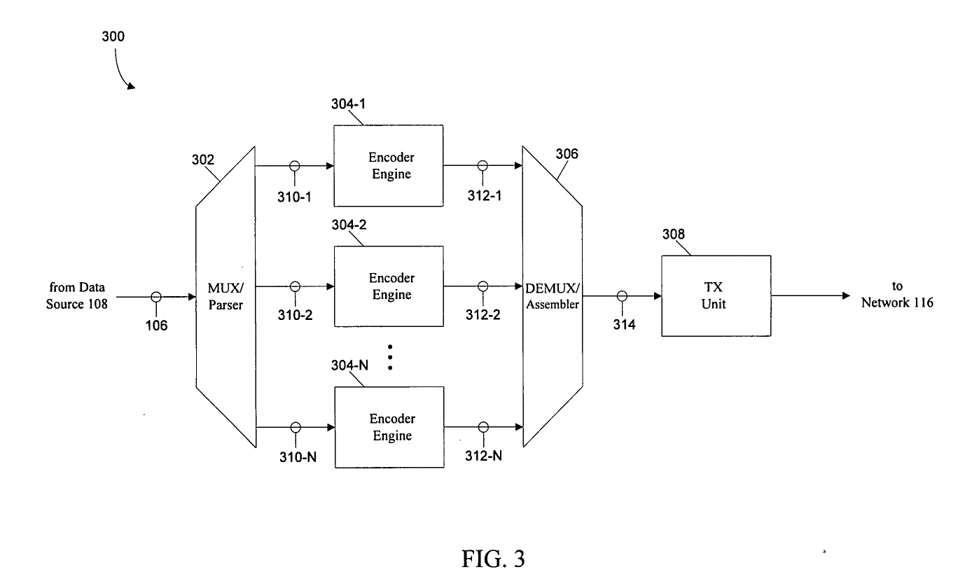

FIG. 3 illustrates an encoder 300 capable of separately encoding multiple segments of an input data stream according to an aspect of the present invention. The encoder 300 allows separate segments of a data stream to be encoded in parallel while ensuring the assembled encoded data stream accommodates the requirements of a corresponding decoder buffer.

The encoder 300 may include a parser 302, a number of encoder engines 304-1 through 304-N, an assembler 306 and a transmitter unit 308. The parser 302 may receive a portion of the source data 106 from the data source 108. The parser 302 divides the portion of the source data 106 into one or more segments 310-1 through 310-N. Each segment 310-1 through 310-N has a begin boundary and an end boundary. Adjacent segments 310 can have overlapping or non-overlapping boundaries. That is, adjacent segments 310 can share common elements or can be completely disjoint. Further, the segments 310-1 through 310-N can be of uniform or variable size with respect to temporal duration or bit length. The parser 302 may parse the source data 106 according to frame type (e.g., generate I frame segments, B frame segments, etc.). The parser may also parse the source data 106 at detected event changes (e.g., at scene changes).

As shown in FIG. 3, the segments 310-1 through 310-N are distributed to respective encoder engines 304-1 through 304-N. Subsequent portions of the source data 106 may also be parsed and sequentially distributed to respective coder engines 304-1 through 304-N. In this way, the parser 302 can be viewed as a multiplexer (MUX).

Each encoder engine 304-1 through 304-N encodes the respective segments 310-1 through 310-N to produce encoded segments 312-1 through 312-N. The encoder engines 304-1 though 304-N can determine and adjust coding parameters to produce the encoded segments 312-1 through 312-N using a multiple pass encoding scheme. The encoded segments 312-1 through 312-N are provided to the assembler 306. The assembler 306 concatenates the separately encoded segments 312-1 through 312-N to produce a portion of an encoded data stream 314. Subsequent encoded segments generated by the encoder engines 304-1 through 304-N may be sequentially concatenated to produce a subsequent encoded portion of the input source data 106. In this way, the assembler 306 can be viewed as operating as a demultiplexer (DEMUX).

As further shown in FIG. 3, the portion of the encoded data stream 314 may be provided to the transmitter unit 308. The transmitter 308 can forward the portion of the encoded data stream 314 to the network 116 for delivery to a corresponding remote decoder. Alternatively, the transmitter unit 308 can store the portion of the encoded data stream 314 in a local or remote memory device.

The encoder 300 uses the encoder engines 304-1 through 304-N to encode each segment 310-1 through 310-N in a parallel manner. By encoding each segment 310-1 through 310-N separately, the encoder 300 allows a given portion of the source data 106 to be encoded more quickly and efficiently. The segments 310-1 through 310-N can be encoded independently. Alternatively, the encoder engines 304-1 through 304-N can interact during their respective encoding processes.

To prevent the assembled portion of the encoded data stream 314 from causing an overflow or underflow condition in a remote decoder buffer, each segment 310-1 through 310-N can be encoded to accommodate the requirements or limitations of the remote decoder buffer. Specifically, the segments 310-1 through 310-N are encoded to accommodate a begin buffer status condition corresponding to each begin boundary of the segments 310-1 through 310-N. Further, the segments 310-1 through 310-N are encoded to accommodate an end buffer status condition corresponding to each end boundary of the segments 310-1 through 310-N.

The begin buffer status condition and the end buffer status condition can be imposed and monitored by modeling the behavior or status of the remote buffer. The behavior of the remote buffer may be modeled by the encoder engines 304-1 through 304-N either individually or collectively. By setting and imposing the buffer status conditions on each boundary of each segment 310-1 through 310-N, the status of the remote decoder buffer assumed during the encoding of each segment 310-1 through 310-N can match the actual remote decoder buffer status resulting from receipt of the assembled portion of the encoded data stream 314.

The begin buffer status condition and the end buffer status condition can be set to a predetermined value or desired capacity level of the remote decoder buffer. For example, the initial and final buffer fullness levels can be set to a 50% fullness condition (or, e.g., any set value between a 50% and 100% fullness condition such as 60%). Alternatively, the begin buffer status condition and the end buffer status condition can be set to a predetermined range or desired capacity window of the remote decoder buffer. For example, the initial and final buffer fullness levels can be set to be within a MIN to MAX fullness range (e.g., centered around a 50% fullness condition or, alternatively, set as a range of 50% to 100% fullness). Under either scenario, the begin and end buffer status conditions are typically equal and are set within a minimum and maximum capacity of the remote buffer. Using multiple pass encoding, the encoder engines 304-1 through 304-N can encode, can adjust coding parameters and then re-encode the segments 310-1 through 310-N as necessary until the begin and end buffer status conditions for each encoded segment 312-1 through 312-N are met or satisfied. In doing so, the encoder 300 prevents an overflow or underflow of the remote decoder buffer at the boundaries of adjacent encoded segments 312-1 through 312-N. In this way, the encoder 300 can prevent inter-segment buffer violations.

Further, the encoder engines 304-1 through 304-N can verify that each respective encoded segment 312-1 through 312-N does not cause an overflow or underflow of the remote decoder buffer between the begin and end boundaries of each individual segment 312. If an overflow or underflow is likely or expected for a given encoded segment 312, then the respective encoder engine 304 can iteratively adjust coding parameters and re-encode a violating segment 310 until both overflow and underflow are prevented. In this way, the encoder 300 can prevent intra-segment buffer violations.

Overall, detected inter-segment and intra-segment buffer violations prompt the encoder engine 304 that produced the violating encoding segment 312 to re-encode the original segment 310. Each re-encoded segment 312 can then be re-examined for both inter-segment and intra-segment buffer violations. Accordingly, multiple passes may be required to produce an encoded segment 312 that does not cause inter-segment and intra-segment buffer violations.

The constituent components of the encoder 300 can be implemented in hardware, software or any combination thereof. Additionally, the encoder engines 304-1 through 304-N can be implemented in software and can reside on separate servers of a computer network. The encoder engines 304-1 through 304-N can implement a variety of encoding algorithms or schemes such as, for example, error control coding (ECC), encryption coding or compression coding. As previously mentioned, the source data 106 can comprise data, voice, audio, video and/or multimedia information. Accordingly, the encoder engines 304-1 through 304-N can implement digital video encoding protocols such as, for example, any one of the Moving Picture Experts Group (MPEG) standards (e.g., MPEG-1, MPEG-2, or MPEG-4) and/or the International Telecommunication Union (ITU) H.264 standard. Further, the encoder engines 304-1 through 304-N can implement a variable bit rate delivery mechanism in the encoded data stream 314 in accordance with Annex E of the ITU H.264 standard. Accordingly, a variable bit rate delivery mechanism can be either implied or signaled in the encoded data stream 314.

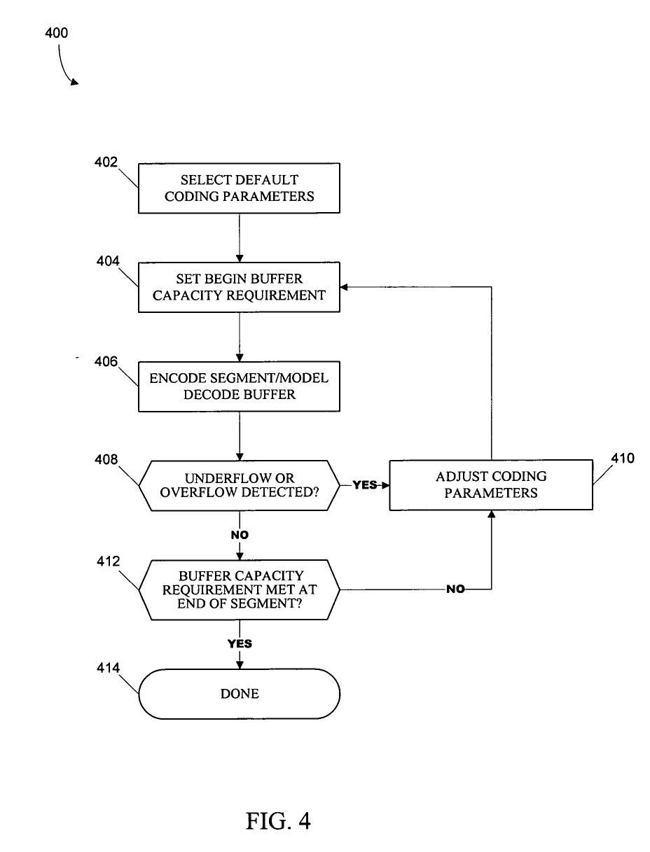

FIG. 4 provides a flowchart 400 of an encoder engine control process for encoding a segment of a data stream to accommodate a set capacity value of an associated remote decoder buffer at the begin and end boundaries of the segment in accordance with an aspect of the present invention. The present invention is not limited to this operational description. Rather, it will be apparent to persons skilled in the relevant art(s) from the teachings herein that other process control flows are within the scope and spirit of the present invention. In the following discussion, the steps in FIG. 4 are described.

At step 402, default coding parameters are selected. The default coding parameters can determine the bit rate at which different portions of a given segment or the entire segment is encoded.

At step 404, the buffer requirement at the beginning of a segment is set. That is, the encoder engine accounts for a desired or set begin buffer status condition. The begin buffer status condition is the same across all encoder engines encoding segments parsed from the same portion of a data stream. The begin buffer status condition can be, for example, the decoder buffer being half full at the beginning of each encoded segment.

At step 406, the segment is encoded to produce an encoded segment. The segment is encoded according to the default coding parameters while accounting for the begin buffer status condition. The status or instantaneous capacity of the remote buffer can also be modeled as the segment is encoded or after the segment is encoded.

At step 408, the status of the modeled buffer is analyzed to detect the presence of any underflow and/or overflow conditions caused by the encoded segment. That is, the status of the modeled buffer is reviewed to verify that overflow and underflow conditions will be prevented. If either an underflow or overflow condition is detected, control flows to step 410. If an underflow and overflow condition is not detected, control flows to step 412.

At step 410, the default coding parameters are adjusted to remedy the underflow and/or overflow condition detected in step 408. Coding parameters for the entire segment or for only a portion of the segment can be adjusted. Control then proceeds to step 404 such that the original unencoded segment can be re-encoded and re-evaluated.

At step 412, the status of the modeled buffer is analyzed to determine if the end buffer status condition is satisfied. That is, the status of the modeled buffer is reviewed to verify the capacity is equal to the end buffer status condition at the end boundary of the encoded segment. The end buffer status condition is generally equal to the begin buffer status condition. If a deviation from the end buffer status condition is detected at the end boundary of the encoded segment, control flows to step 410. At step 410, the default coding parameters are adjusted to remedy the violation detected in step 412. Coding parameters for the entire segment or for only a portion of the segment can be adjusted. Control then proceeds to step 404 such that the original unencoded segment can be re-encoded and re-evaluated. If the end buffer status condition is met at the end boundary of the encoded segment, control flows to step 414.

At step 414, an encoded segment is produced having the following properties: (1) the begin boundary of the encoded segment can be received without error by a remote decoder buffer having a capacity level equal to the begin buffer status condition; (2) the encoded segment will compel the capacity of the remote decode buffer to be equal to the end buffer status condition at the end boundary of the encoded segment; and (3) the encoded segment prevents an overflow or underflow condition from occurring between the begin and end boundaries of the encoded segment.

As shown in FIG. 4, the control process 400 illustrates an iterative or multiple pass encoding process. The verification step 408 prevents the remote decoder buffer from entering an overflow or underflow condition within the begin and end boundaries of each encoded segment. The verification step 412 ensures that the capacity requirements of the decoder buffer at the begin and end boundaries of each encoded segment are equal to a predetermined value.

It is important to note that the first encoded segment of a data stream does not need to meet the begin buffer status condition since the decoder buffer is presumed to be empty when an encoded data stream is first received. Additionally, the last encoded segment of a data stream does not need to meet the end buffer status condition since the decoder buffer is presumed to not receive any further encoded segments. The first segment can therefore be encoded such that at the start of receipt the decoder buffer is empty and at the end of receipt the buffer is equal to the predetermined value. Subsequent clips can be encoded such that at the beginning and end of each segment the decoder buffer is also equal to the predetermined value. Lastly, the final segment can be encoded such that at the beginning the buffer is equal to the predetermined value and at the end of the final segment the buffer can be full. In this way, all segments can be encoded independently without any knowledge of the coding results (buffer status) caused by other segments.

FIG. 7A illustrates a graph of decoder buffer volume that might occur in a hypothetical encoding scenario. Specifically, a curve 702 represents the amount of data contained in the receiver buffer over time as determined by a received encoded data stream generated by a conventional encoder-decoder system. The curve 702 is compared to a half-full state of the decoder buffer.

FIG. 7B illustrates the graph of FIG. 7A in which an aspect of the present invention has been applied. As shown in FIG. 7B, the original graph is split into three segments (shown as a first segment 708, a second segment 710 and a third segment 712). Each segment can be encoded by separate encoders. The original curve 702 is represented by a dashed line across all segments. A solid line curve 704 represents buffer fullness resulting from encoding operations as applied by an aspect of the present invention. Specifically, the curve 704 is generated by independent encoders that compel the decoder buffer to be half-full at all inter-clip boundaries. The curve 704 can result from the encoding process illustrated by FIG. 4 for example.

Coding parameters are revised at the end of the first segment 708 to bring the buffer volume down to the half-full mark. In an embodiment, only a portion of the coding parameters for the entire first segment 708 are adjusted. For example, only coding parameters from the most recent local minimum of the first segment 708 can be adjusted. Assuming the first segment 708 is the first segment overall, the buffer fullness at the beginning of the first segment 708 does not need to equal to the half-full mark.

In the second segment 710, a dotted curve 706-A represents the original curve 702 shifted to bring buffer fullness down to the half-full mark at the beginning of the second segment 710. As shown, this shift causes an underflow. Further, this shift fails to return the buffer fullness to the half-full state at the end of the second segment 710. Both of theses violations are detected by the encoder-decoder system of the present invention. Accordingly, the present invention revises coding parameters to resolve both violations.

In the third segment 712, a dotted curve 706-B represents the original curve 702 shifted to bring the bring buffer fullness up to the half-full mark at the beginning of the third segment 712. As shown, this shift causes an overflow. This violation is detected by the encoder-decoder system of the present invention. Accordingly, the present invention revises coding parameters to resolve the violation. Assuming the third segment 712 is the last overall segment, the buffer fullness does not need to equal the half-full mark at the end of the third segment 712.

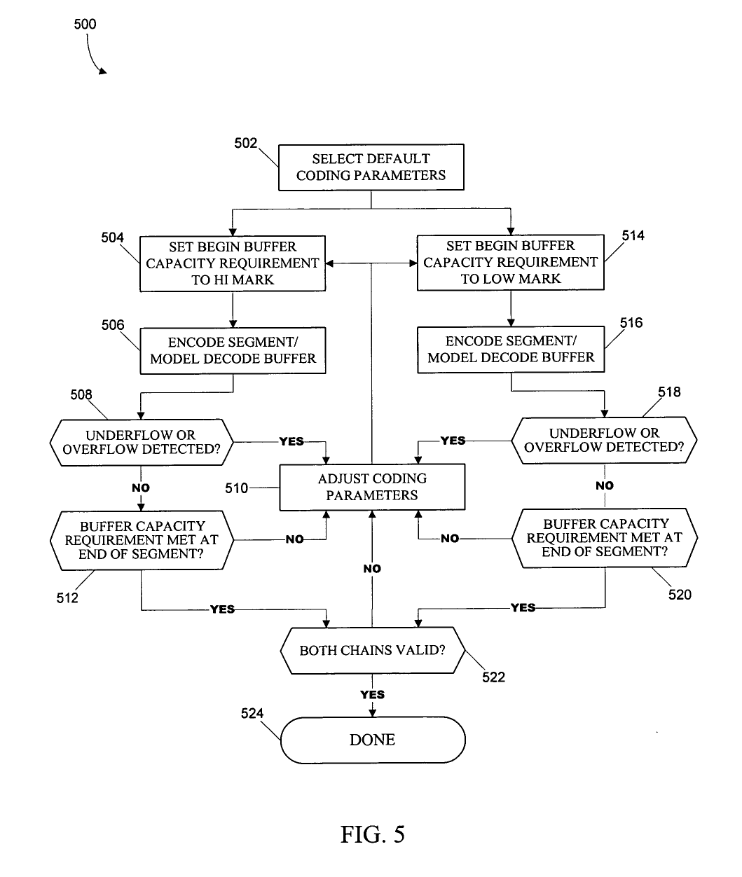

FIG. 5 provides a flowchart 500 of an encoder engine control process for encoding a segment of a data stream to accommodate a required capacity range of an associated remote decoder at the begin and end boundaries of the segment in accordance with an aspect of the present invention. The present invention is not limited to this operational description. Rather, it will be apparent to persons skilled in the relevant art(s) from the teachings herein that other process control flows are within the scope and spirit of the present invention. In the following discussion, the steps in FIG. 5 are described.

At step 502, default coding parameters are selected. The default coding parameters can determine the bit rate at which different portions of a given segment or the entire segment is encoded.

At step 504, the buffer requirement at the beginning of a segment is set to the highest value within a desired range comprising the begin buffer status condition. The range of the begin buffer status condition is the same across all encoder engines encoding segments parsed from the same portion of a data stream.

At step 506, the segment is encoded to produce an encoded segment. The segment is encoded according to the default coding parameters while accounting for the maximum value of the begin buffer status condition. The status or instantaneous capacity of the remote buffer can also be modeled as the segment is encoded or after the segment is encoded.

At step 508, the status of the modeled buffer is analyzed to detect the presence of any underflow and/or overflow conditions caused by the encoded segment. That is, the status of the modeled buffer is reviewed to verify that overflow and underflow conditions will be prevented. If either an underflow or overflow condition is detected, control flows to step 510. If an underflow and overflow condition is not detected, control flows to step 512.

At step 512, the status of the modeled buffer is analyzed to determine if the end buffer status condition is satisfied. That is, the status of the modeled buffer is reviewed to verify the capacity is within a range comprising the end buffer status condition. The range of the end buffer status condition is equal to the range of begin buffer status condition. If a deviation from the end buffer status condition is detected at the end boundary of the encoded segment, control flows to step 510. If the end buffer status condition is met at the end boundary of the encoded segment, control flows to step 522.

Steps 502-508 and 512 represent a first branch or chain of the control process illustrated by flowchart 500. This first chain is implemented to ensure an encoded segment prevents an overflow or underflow condition when the capacity of the decoder buffer is initially set to the high end of the begin buffer status condition.

At step 514, the buffer requirement at the beginning of a segment is set to the lowest value within a desired range comprising the begin buffer status condition.

At step 516, the segment is encoded to produce an encoded segment. The segment is encoded according to the default coding parameters while accounting for the minimum value of the begin buffer status condition. The status or instantaneous capacity of the remote buffer can also be modeled as the segment is encoded or after the segment is encoded.

At step 518, the status of the modeled buffer is analyzed to detect the presence of any underflow and/or overflow conditions caused by the encoded segment. That is, the status of the modeled buffer is reviewed to verify that overflow and underflow conditions will be prevented. If either an underflow or overflow condition is detected, control flows to step 510. If an underflow and overflow condition is not detected, control flows to step 520.

At step 520, the status of the modeled buffer is analyzed to determine if the end buffer status condition is satisfied. That is, the status of the modeled buffer is reviewed to verify the capacity is within a range comprising the end buffer status condition. If a deviation from the end buffer status condition is detected at the end boundary of the encoded segment, control flows to step 510. If the end buffer status condition is met at the end boundary of the encoded segment, control flows to step 522.

Steps 514-520 represent a second branch or chain of the control process illustrated by flowchart 500. This second chain is implemented to ensure an encoded segment prevents an overflow or underflow condition when the capacity of the decoder buffer is initially set to the low end of the begin buffer status condition.

Step 522 is implemented after the first and/or second chain of the control process are conducted. The first and second chains can be conducted sequentially or in parallel. Step 522 verifies that both control chains of the control process have been conducted and produce valid results.

Strep 510 is implemented when either chain or both chains are invalid. Coding parameters for the entire segment or for only a potion of the segment can be adjusted. Control then proceeds to step 504 and/or 514 such that the original unencoded segment can be re-encoded and re-verified.

Step 524 is reached when both chains are valid. At step 524, an encoded segment emerges having the following properties: (1) the begin boundary of the encoded segment can be received without error by a remote decoder buffer having a capacity level within the range specified by the begin buffer status condition; (2) the encoded segment will compel the capacity of the remote decode buffer to be within the range of the end buffer status condition at the end boundary of the encoded segment; and (3) the encoded segment prevents an overflow or underflow condition from occurring between the begin and end boundaries of the encoded segment.

As shown in FIG. 5, the control process 500 illustrates an iterative or multiple pass encoding process of a segment of a data stream. The verification steps 508 and 512 check the validity of an encoded segment if received by a decoder buffer having an initial capacity set to a maximum value of the begin buffer status condition. Specifically, the verification step 508 checks whether the remote decoder buffer will enter an overflow or underflow condition within the begin and end boundaries of an encoded segment. The verification step 512 ensures that the capacity requirement of the end boundary of an encoded segment is within the range specified by the end buffer status condition.

Similarly, the verification steps 518 and 520 check the validity of an encoded segment if received by a decoder buffer having an initial capacity set to a minimum value of the begin buffer status condition. Specifically, the verification step 518 checks whether the remote decoder buffer will enter an overflow or underflow condition within the begin and end boundaries of an encoded segment. The verification step 520 ensures that the capacity requirement of the end boundary of an encoded segment is within the range specified by the end buffer status condition.

It is important to note for FIG. 5 that the first encoded segment of a data stream does not need to meet the begin buffer status condition since the decoder buffer is presumed to be empty when an encoded data stream is first received. Additionally, the last encoded segment of a data stream does not need to meet the end buffer status condition since the decoder buffer is presumed to not receive any further encoded segments. The first segment can therefore be encoded such that at the start of receipt the decoder buffer is empty and at the end of receipt the buffer is within a predetermined range. Subsequent clips can be encoded such that at the beginning and end of each segment the decoder buffer is also within the predetermined range. Lastly, the final segment can be encoded such that at the beginning the buffer is within the predetermined range but at the end of the final segment, the buffer can be full. In this way, all segments can be encoded independently without any knowledge of the coding results (buffer status) caused by other segments.

In a further aspect of the present invention (e.g., as illustrated by FIGS. 3, 4 or 5), after the independent encodings are completed, the decoder buffer status over all encoded segments (or an assembled encoded data stream) can be determined and analyzed. This allows the boundaries of adjacent encoded segment to be adjusted or re-encoded to best meet the particular requirements or needs of a pair of adjacent segments.

As previously mentioned, the parser 302 illustrated in FIG. 3 can generate overlapping segments of the portion of the data stream 106. Under this scenario, adjacent encoder engines 304 can determine a dynamic boundary condition based on the overlapping region shared by adjacent segments. In doing so, the adjacent encoder engines 304 can share information relating to coding parameters and modeled buffer status to jointly encode a shared boundary. Alternatively, the overlapping regions can be re-encoded after independent encoding of adjacent overlapping segments.

Further, it is important to note that coding adjustments made by the encoder engines 304-1 through 304-N can be implemented using a variety of methods. For example, coding parameters can be adjusted to ensure constant bit rate encoding or, alternatively, variable bit rate encoding of a segment. For video data streams, each parsed segment can represent a clip of video, with each clip containing multiple frames. Coding adjustments can therefore be made within a given frame, across several frames or across several clips as described in co-pending application Ser. No. 11/118,616, filed Apr. 28, 2005, herein incorporated by reference in its entirety. Typically, a quantization parameter (qp) is used to adjust the bit rate of the encoding process. The quantization parameter is increased to lower bit rate and is decreased to increase bit rate. The quantization parameter can also be based on a masking function φᵣ. The masking function φᵣ can be used to define areas of high and low activity of a video picture. Regions of higher activity typically require a higher bit rate while regions defined as low activity may require a lower bit rate, thereby determining a corresponding encoding bit rate.

FIG. 8A illustrates a graph of decoder buffer volume that might occur in a hypothetical encoding scenario. Specifically, a curve 802 represents the amount of data contained in the receiver buffer over time as determined by a received encoded data stream generated by a conventional encoder-decoder system.

FIG. 8B illustrates the graph of FIG. 8A in which an aspect of the present invention has been applied. As shown in FIG. 8B, the original graph is split into three segments (shown as a first segment 802, a second segment 804 and a third segment 806). Each segment can be encoded by separate encoders. A solid line curve 808 represents buffer fullness resulting from encoding operations as applied by an aspect of the present invention. Specifically, the curve 808 is generated by independent encoders that compel the decoder buffer volume to be within a range (e.g., between “HI” and “LO”) at all inter-clip boundaries. The curve 808 can result from the encoding process illustrated by FIG. 5 for example.

The buffer volume at the end of the first segment 802 is within the HI to LO range. Further, the buffer volume does not enter an underflow or overflow condition within the first segment 802. Accordingly, the encoded version of the first segment 802 does not need to be re-encoded.

In the second segment 804, a dashed curve 810-A represents the original curve 802 shifted to bring buffer fullness down to the HI mark at the beginning of the second segment 804. As shown, this shift causes an underflow. Further, this shift fails to return the buffer fullness to within the HI-LO range at the end of the second segment 804. Both of theses violations are detected by the encoder-decoder system of the present invention. Accordingly, the present invention revises coding parameters to resolve both violations.

Also in the second segment 804, a dashed curve 812-A represents the original curve 802 shifted to bring buffer fullness down to the LO mark at the beginning of the second segment 804. As shown, this shift causes an underflow. Further, this shift fails to return the buffer fullness to within the HI-LO range at the end of the second segment 804. Both of theses violations are detected by the encoder-decoder system of the present invention. Accordingly, the present invention revises coding parameters to resolve both violations.

For all segments except the first segment 802, two replicas of the graph are evaluated. A first replica evaluates the graph when started at the HI mark at the beginning of the segment. A second replica evaluates the graph when started at the LO mark at the beginning of the segment. Both replicas are then evaluated for underflows and overflows. Further, on every segment except the last segment 806, both replicas are evaluated to determine if the buffer volume at the end of the segment is within the HI-LO range. If any violation is detected for either replica, then coding parameters are reselected and the segment is re-encoded.

Both replicas can be generated by encoding a segment twice. For example, the segment is coded a first time with the assumption that the buffer is at the HI mark to produce the first replica. The segment is then coded a second time with the assumption that the buffer is at the LO mark to produce the second replica. Alternatively, the segment can be coded once and then shifted accordingly (to the HI and LO begin boundary marks) to evaluate both replicas.

In the third segment 806, a dashed curve 810-B represents the original curve 802 shifted to bring buffer fullness up to the HI mark at the beginning of the third segment 806. As shown, this shift causes an overflow. This violation is detected by the encoder-decoder system of the present invention. Accordingly, the present invention revises coding parameters to resolve the violation.

Also in the third segment 806, a dashed curve 812-B represents the original curve 802 shifted to bring buffer fullness down to the LO mark at the beginning of the third segment 806. As shown, this shift does not cause a violation. Using the results of both replicas, the present invention adjusts coding parameters to generate the resulting solid line curve 808 in a subsequent coding iteration.

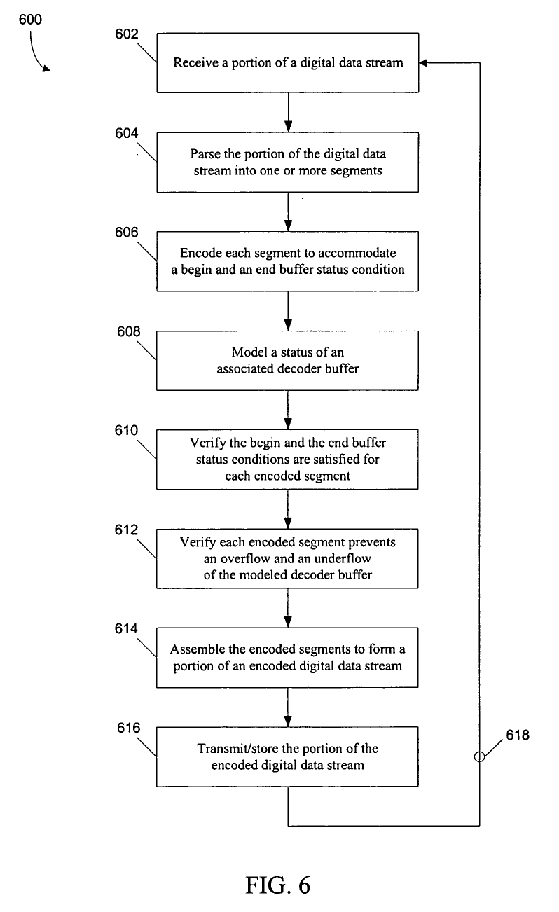

FIG. 6 provides a flowchart 600 illustrating operational steps for encoding a portion of a digital data stream according to an aspect of the present invention. Specifically, FIG. 6 provides a description of the operation of an encoder of the present invention. The present invention is not limited to this operational description. Rather, it will be apparent to persons skilled in the relevant art(s) from the teachings herein that other process control flows are within the scope and spirit of the present invention. In the following discussion, the steps in FIG. 6 are described.

At step 602, a portion of a digital data stream is received. The digital data stream comprises data, voice, audio, video and/or multimedia information.

At step 604, the portion of the digital data stream is parsed into segments. The segments can be of uniform or varying size with respect to temporal duration or bit length. Further, the segments can be overlapping or non-overlapping.

At step 606, each segment is separately encoded to accommodate a begin buffer status condition and an end buffer status condition to produce respective encoded segments. The segments can be encoded in parallel. Further, the segments can be encoded independently. Alternatively, overlapping regions of adjacent overlapping segments can be jointly encoded. The begin buffer status condition and the end buffer status condition can be equal to a predetermined value or a predetermined range of values.

The segments can be encoded using a compression, encryption or an error control coding algorithm. For example, the segments can be encoded using any one of the MPEG standards (e.g., MPEG-1, MPEG-2, or MPEG-4) or the ITU H.264 standard.

At step 608, the status of an associated decoder buffer is modeled.

At step 610, each encoded segment is analyzed or reviewed to verify that each encoded segment satisfies the begin buffer status condition and the end buffer status condition. Any segment violating the begin buffer status condition or end buffer status condition is re-encoded and re-verified. The coding parameters used to encode any violating segment are adjusted during the re-encoding process.

At step 612, each encoded segment is analyzed or reviewed to verify that each encoded segment prevents and underflow or an underflow of the modeled decoder buffer. Any segment causing an underflow or an underflow is re-encoded and re-verified. The coding parameters used to encode any violating segment are adjusted during the re-encoding process.

Steps 610 and 612 are repeated for each encoded segment that is re-encoded.

At step 614, the encoded segments are assembled to form a portion of an encoded digital data stream. The portion of the encoded digital data stream can be formed by concatenating the individual encoded segments.

At step 616, the portion of the encoded digital data stream is transmitted to a remote decoder buffer over a network. Alternatively, the portion of the encoded digital data stream is provided to a memory device for storage or for store-and-forward delivery to the remote decoder buffer.

Step 618 illustrates the continuous encoding operation provided by an aspect of the present invention. That is, step 618 shows that steps 602-616 are repeated for subsequent portions of the input digital data stream.

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. A method of coding video data, comprising:
parsing a video data sequence into separate segments,
coding each segment independently of the other segments by an iterative coding process, comprising:
coding a respective segment according to default coding parameters,
modeling buffer fullness at a receiver based on an estimated initial buffer fullness level and the coded segment, and
if the modeled buffer fullness reaches a violation condition or if the modeled buffer fullness at an end of the respective segment fails to reach an estimated final buffer fullness level, modifying the coding parameters for a next iteration of the coding process; and
multiplexing the coded segments into a coded video data signal.

2. The method of claim 1, wherein the estimated initial buffer fullness level is a set value between a 50% and a 100% fullness condition.

3. The method of claim 2, wherein the set value is 60%.

4. The method of claim 1, wherein the estimated final buffer fullness level is a set value between a 50% and a 100% fullness condition.

5. The method of claim 4, wherein the set value is 60%.

6. The method of claim 1, wherein the estimated initial buffer fullness level is a fullness condition MIN to MAX range.

7. The method of claim 6, wherein the fullness condition MIN to MAX range is from a 50% to a 100% fullness condition.

8. The method of claim 1, wherein the estimated final buffer fullness level is a fullness condition MIN to MAX range.

9. The method of claim 8, wherein the fullness condition MIN to MAX range is from a 50% to a 100% fullness condition.

10. The method of claim 1, further comprising re-coding boundaries of adjacent coded segments.

11. A method for encoding a portion of a digital data stream, comprising:
parsing the portion of the digital data stream into a plurality of segments, each segment having a begin boundary and an end boundary;
encoding each segment separately to accommodate a begin buffer status condition corresponding to each begin boundary and an end buffer status condition corresponding to each end boundary; and
assembling the encoded segments to form a portion of an encoded digital data stream.

12. The method of claim 11, wherein encoding comprises encoding each segment in parallel.

13. The method of claim 11, wherein encoding comprises encoding each segment independently.

14. The method of claim 11, further comprising modeling a decoder buffer.

15. The method of claim 14, further comprising verifying the begin buffer status condition and the end buffer status condition are satisfied for each encoded segment received by the modeled decoder buffer.

16. The method of claim 15, further comprising re-encoding each encoded segment violating one of the begin buffer status condition and the end buffer status condition.

17. The method of claim 14, further comprising verifying each encoded segment prevents an overflow and an underflow of the modeled decoder buffer between a begin boundary and an end boundary of each encoded segment.

18. The method of claim 17, further comprising re-encoding each encoded segment causing one of the overflow and the underflow of the modeled decoder buffer.

19. The method of claim 11, wherein the begin buffer status condition and the end buffer status condition comprise a predetermined value between a maximum capacity and a minimum capacity of the modeled decoder buffer.

20. The method of claim 11, wherein the begin buffer status condition and the end buffer status condition comprise a predetermined range between a maximum capacity and a minimum capacity of the decoder buffer.

21. The method of claim 11, further comprising re-encoding boundaries of adjacent encoded segments.

22. The method of claim 11, wherein parsing comprises parsing the portion of the digital data stream into a plurality of overlapping segments.

23. The method of claim 22, further comprising jointly encoding an shared region of adjacent overlapping segments.

24. The method of claim 11, wherein assembling comprises concatenating the encoded segments.

25. An encoder, comprising:
a parser to divide a portion of a digital data stream into a plurality of segments, each segment having a begin boundary and an end boundary;
a plurality of encoder engines to independently encode the plurality of segments to accommodate a begin buffer status condition corresponding to each begin boundary and an end buffer status condition corresponding to each end boundary, thereby producing a plurality of corresponding encoded segments; and
an assembler to combine the plurality of encoded segments to form a portion of an encoded digital data stream.

26. The encoder of claim 25, wherein the plurality of encoder engines implement a compression algorithm.

27. The encoder of claim 26, wherein the compression algorithm is one of the Moving Picture Experts Group (MPEG) video compression standards.

28. The encoder of claim 26, wherein the compression algorithm is an International Telecommunication Union (ITU) H.264 standard.

29. The encoder of claim 28, wherein the portion of the encoded digital data stream includes a variable bit rate delivery mechanism in accordance with Annex E of the ITU H.264 standard.

30. The encoder of claim 25, wherein the plurality of encoder engines verify the begin buffer status condition and the end buffer status condition are satisfied for the plurality of encoded segments.

31. The encoder of claim 30, wherein the plurality of encoder engines re-encode any encoded segment violating one of the begin buffer status condition and the end buffer status condition.

32. The encoder of claim 25, wherein the plurality of encoder engines verify the plurality of encoded segments prevent an overflow and an underflow of a modeled decoder buffer.

33. The encoder of claim 32, wherein the plurality of encoder engines re-encode any encoded segment causing one of the overflow and the underflow of the modeled decoder buffer.

34. The encoder of claim 25, wherein the begin buffer status condition and the end buffer status condition comprise a predetermined value between a maximum capacity and a minimum capacity of a modeled decoder buffer.

35. The encoder of claim 25, wherein the begin buffer status condition and the end buffer status condition comprise a predetermined range between a maximum capacity and a minimum capacity of a modeled decoder buffer.

36. A method for encoding a portion of a digital data stream, comprising:
parsing the portion of the digital data stream into one or more segments;
encoding the one or more segments such that a begin boundary of each encoded segment accounts for a begin buffer status condition of a modeled decoder buffer;
verifying the one or more encoded segments prevent an overflow and an underflow of the modeled decoder buffer; and
verifying the one or more encoded segments satisfy an end buffer status condition at an end boundary of each encoded segment.

37. The method of claim 36, further comprising re-encoding any encoded segment causing an underflow or an overflow of the modeled decoder buffer.

38. The method of claim 36, further comprising re-encoding any encoded segment violating the end buffer status condition.

39. The method of claim 36, further comprising concatenating the one or more encoded segments to form a portion of an encoded digital data stream.

40. The method of claim 36, wherein the begin buffer status condition and the end buffer status condition comprise a predetermined value between a minimum capacity and a maximum capacity of the modeled decoder buffer.

41. The method of claim 36, wherein the begin buffer status condition and the end buffer status condition comprise a predetermined range between a minimum capacity and a maximum capacity of the modeled decoder buffer.
